(19) United States
(12) Patent Application Publication
(10) Pub. No.: US 2025/0354647 A1
(43) Pub. Date: Nov. 20, 2025

(54) ROTATING SHAFT MODULE AND FUNCTIONAL DEVICE

(71) Applicant: Guangzhou Luxvisions Innovation Technology Limited, Guangzhou City (CN)

(72) Inventors: Ta Yi Lee, Guangzhou City (CN); Hsien Liang Cheng, Guangzhou City (CN)

(73) Assignee: Guangzhou Luxvisions Innovation Technology Limited, Guangzhou City (CN)

(21) Appl. No.: 19/008,894

(22) Filed: Jan. 3, 2025

(30) Foreign Application Priority Data
May 20, 2024 (CN) 202421106087.6

(51) Int. Cl. F16M 11/10; F16M 11/26

(52) U.S. Cl. CPC F16M 11/10; F16M 11/26

(57) ABSTRACT

The present application relates to a rotating shaft module and a functional device. The rotating shaft module includes: a first support member defining a first mounting cavity; a rotating member rotatably connected to the first support member; a slider movably arranged in the first mounting cavity, where a first rotating shaft is mounted at the end of the slider close to the rotating member, and the rotating member can abut against the first rotating shaft; and an elastic member arranged in the first mounting cavity, located on the side of the slider away from the rotating member and abutting against the slider. The first rotating shaft is in contact with the rotating member, and the first rotating shaft can rotate during the contact with the rotating member, thereby reducing friction of the rotating member on the slider and prolonging the service life of the slider.

### FIELD

The present application relates to the technical field of rotating shaft modules, in particular to a rotating shaft module and a functional device.

### BACKGROUND

Considering use convenience for users, hinge modules of multi-functional peripherals (MFPs) and copy machines in the current market usually have multi-angle support functions, based on the design principle that a cam shaft is in contact with a slider mounted in a frame, at least one compression spring is provided at the bottom of the slider, and a cam rotates to change the relative height of the slider, thereby compressing the spring to produce support force. As the slider usually maintains contact and friction with the cam in a relatively small area for a long time, the slider wears in the relatively small area, which affects the opening and stop angle of a rotating shaft module.

### SUMMARY

The present application provides a rotating shaft module to solve the problem of slider wear during long-term use of the rotating shaft module.

The present application provides a functional device including the aforementioned rotating shaft module.

The rotating shaft module according to the present application includes:
a first support member defining a first mounting cavity;
a rotating member rotatably connected to the first support member;
a slider movably arranged in the first mounting cavity, where a first rotating shaft is mounted at the end of the slider close to the rotating member, and the rotating member can abut against the first rotating shaft; and
an elastic member arranged in the first mounting cavity, located on the side of the slider away from the rotating member and abutting against the slider.

According to the rotating shaft module of the present application, the rotating member includes a cam portion, the slider includes a protrusion, the first rotating shaft is provided on the protrusion, and the cam portion abuts against the first rotating shaft.

Optionally, the protrusion is provided with a limit groove, and a portion of the first rotating shaft is embedded into the limit groove.

Optionally, the protrusion is provided with two opposite assembly holes, and the first rotating shaft is inserted into the assembly holes.

Optionally, a bearing is further inserted into the assembly hole, and the bearing is sleeved on the first rotating shaft.

Optionally, the first rotating shaft is a metal or plastic part.

Optionally, a stop portion is provided on the protrusion, the stop portion is arranged on an outer side of the first rotating shaft, and the stop portion is spaced apart from the cam portion.

The rotating shaft module of the present application further includes a second support member, the second support member is arranged in the first mounting cavity, the second support member is detachably connected to the first support member, the second support member further defines a second mounting cavity, the rotating member is rotatably connected to both the first support member and the second support member, and the slider and the elastic member are both arranged in the second mounting cavity.

Optionally, the second support member is a metal part; and/or the first support member is provided with a guide portion, the second support member is provided with a guide groove, and the guide portion is clamped into the guide groove.

The functional device of the present application includes the aforementioned rotating shaft module.

Compared to existing technologies, the above technical solutions provided in the embodiments of the present application have the following advantages:

According to the rotating shaft module provided in the embodiments of the present application, the first rotating shaft is in contact with the rotating member, and the first rotating shaft can rotate during the contact with the rotating member, thereby reducing friction of the rotating member on the slider and prolonging the service life of the slider.

### BRIEF DESCRIPTION OF THE DRAWINGS

The accompanying drawings herein are incorporated into the specification and constitute a part of the specification, show embodiments conforming to the utility model, and are used with the specification to explain the principles of the utility model.

In order to describe the technical solutions in the embodiments of the utility model or in the prior art more clearly, the following briefly introduces the accompanying drawings required for use in the description of the embodiments or the prior art. Apparently, those of ordinary skill in the art can derive other drawings from the accompanying drawings without any creative effort.

One or more embodiments are exemplified by the corresponding accompanying drawings. The exemplified descriptions do not constitute limitations on the embodiments. The elements with the same reference numerals in the accompanying drawings are denoted as similar elements. Unless otherwise stated, the accompanying drawings do not constitute proportional limitations.

FIG. 1 is a perspective view of a partial structure of a rotating shaft module provided in an embodiment of the present application;

FIG. 2 is an enlarged view of part A in FIG. 1;

FIG. 3 is a side view of a rotating shaft module provided in an embodiment of the present application;

FIG. 4 is a perspective view of a partial structure of a rotating shaft module provided in an embodiment of the present application; and

FIG. 5 is a perspective view of a rotating shaft module provided in an embodiment of the present application.

### DESCRIPTION OF REFERENCE NUMERALS

First support member 10, rotating member 20, cam portion 21, protrusion 22, assembly hole 221, second rotating shaft 23, slider 30, first rotating shaft 31, stop portion 32, elastic member 40, second support member 50, guide groove 51.

### DETAILED DESCRIPTION

In order to make the objectives, technical solutions and advantages of the embodiments of the present application clearer, the technical solutions in the embodiments of the present application will be described clearly and completely below in conjunction with the accompanying drawings therein. Apparently, the described embodiments are some of the embodiments of the present application, not all of them. Based on the embodiments of the present application, all other embodiments obtained by those of ordinary skill in the art without any creative effort shall fall within the scope of protection of the present application.

The following disclosure provides many different embodiments or examples for implementing different structures of the utility model. In order to simplify the disclosure of the utility model, the components and settings of specific examples are described below. Of course, they are only examples and are not intended to limit the utility model. In addition, the utility model can repeatedly refer to numbers and/or letters in different examples. The repetition is for the purpose of simplification and clarity, and does not indicate the relationship between various discussed embodiments and/or settings.

For ease of description, spatial relative relationship terms can be used herein to describe the relative position or motion of one element or feature shown in the figures relative to the other element or feature. These relative relationship terms include “internal”, “external”, “inner”, “outer”, “below”, “under”, “on”, “above”, “front”, “rear”, etc. The spatial relative relationship terms are intended to include different orientations of an apparatus in use or operation, in addition to the orientations depicted in the figures. For example, if the apparatus in the figures undergoes a position flip, posture change, or motion state change, these directional indications also change accordingly. For example, one element described as “below the other element or feature” or “under the other element or feature” will subsequently be oriented as “on the other element or feature” or “above the other element or feature”. Therefore, the exemplary term “under” may include both upper and lower orientations. The apparatus can be oriented otherwise (rotated 90 degrees or in other directions) and the spatial relative relationship descriptors used herein are explained accordingly.

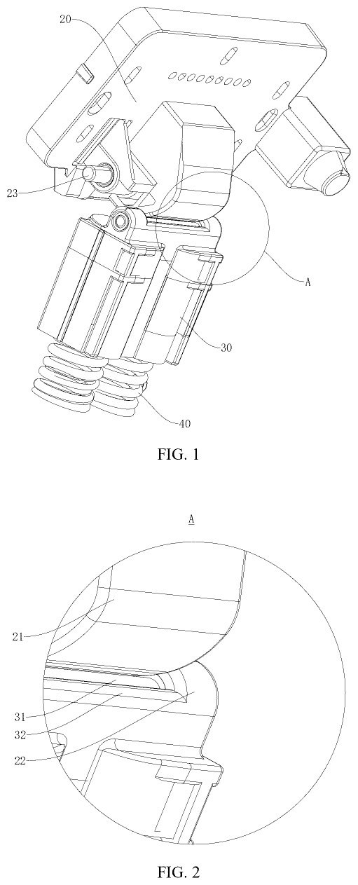

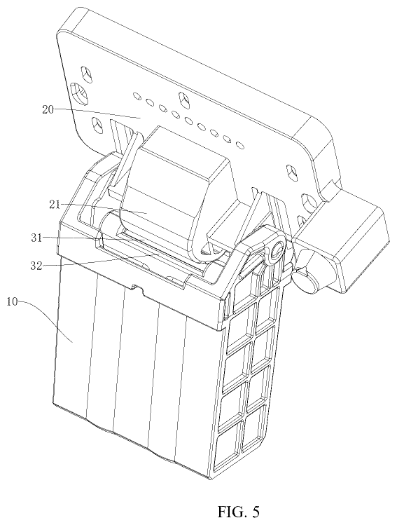

As shown in FIGS. 1-3 and 5, a rotating shaft module according to the embodiments of the present application includes a first support member 10, a rotating member 20, a slider 30, and an elastic member 40.

Specifically, the first support member 10 defines a first mounting cavity; the rotating member 20 is rotatably connected to the first support member 10; the slider 30 is movably arranged in the first mounting cavity, a first rotating shaft 31 is mounted at the end of the slider 30 close to the rotating member 20, and the rotating member 20 can abut against the first rotating shaft 31; the elastic member 40 is arranged in the first mounting cavity, and the elastic member 40 is located on the side of the slider 30 away from the rotating member 20 and abuts against the slider 30.

To elaborate, the first support member 10 defines the first mounting cavity, and the rotating member 20 is rotatably connected to the first support member 10, so that the first support member 10 can support the rotating member 20. The elastic member 40 is arranged in the first mounting cavity, and the elastic member 40 is located on the side of the slider 30 away from the rotating member 20 and abuts against the slider 30, that is, the slider 30 is arranged between the rotating member 20 and the elastic member 40, and the slider 30 abuts against the rotating member 20 and the elastic member 40 simultaneously. During the rotation of the rotating member 20, the rotating member 20 presses against the slider 30 and then against the elastic member 40. Under the action of the elastic member 40, the rotating member 20 produces a portion of horizontal lateral component force on the slider 30. The horizontal lateral component force acts on the first rotating shaft 31 to ensure rotating contact between the rotating member 20 and the first rotating shaft 31, thereby avoiding wear of the slider 30 caused by the rotating member 20 and prolonging the service life of the rotating shaft module.

In addition, the first rotating shaft 31 can also provide some support for the rotating member 20, to ensure that the rotating member 20 can stay in any position when rotating thereto, and to maintain balance and stability.

The first support member 10 defines the first mounting cavity, and the first mounting cavity may be configured in any desired shape, such as rectangular, cubic, cylindrical, or elliptical cylindrical. In the embodiment shown in FIG. 1, the first mounting cavity is configured in a rectangular shape.

In the rotating shaft module according to the embodiments of the present application, the first rotating shaft 31 is in contact with the rotating member 20, and the first rotating shaft 31 can rotate during the contact with the rotating member 20, thereby reducing friction of the rotating member 20 on the slider 30 and prolonging the service life of the slider 30.

As shown in FIGS. 1-4, in the rotating shaft module according to the embodiments of the present application, the rotating member 20 includes a cam portion 21, the slider 30 includes a protrusion 22, the first rotating shaft 31 is provided on the protrusion 22, and the cam portion 21 abuts against the first rotating shaft 31.

In detail, the rotating member 20 includes the cam portion 21, the slider 30 includes the protrusion 22, the first rotating shaft 31 is provided on the protrusion 22, the cam portion 21 abuts against the first rotating shaft 31, and the cooperation between the cam portion 21 and the first rotating shaft 31 can hover the rotating member 20 at multiple angles when rotating to achieve balance, thereby greatly improving convenience for users. By providing the protrusion 22 on the slider 30 and then providing the first rotating shaft 31 on the protrusion 22, the distance between the first rotating shaft 31 and the rotating member 20 can be shortened using the protrusion 22, and the cam portion 21 can be avoided using a gap between the protrusion 22 and an edge of the slider 30.

As shown in FIG. 3, in some embodiments, the protrusion 22 is provided with two opposite assembly holes 221, and the first rotating shaft 31 is inserted into the assembly holes 221.

In detail, the first rotating shaft 31 is inserted into the assembly holes 221, so that the first rotating shaft 31 is supported and limited by the assembly holes 221, and the first rotating shaft 31 can be rotatably arranged on the protrusion 22. In a specific assembly process, the first rotating shaft 31 is first inserted into the assembly holes 221 from one end and then mated with the assembly holes 221 by means of limit members to prevent the first rotating shaft 31 from coming out of any of the assembly holes 221.

In some embodiments, the protrusion 22 is provided with a limit groove, and a portion of the first rotating shaft 31 is embedded into the limit groove. Thus, the first rotating shaft 31 can be limited, and the first rotating shaft 31 is allowed to contact the rotating member 20. The limit groove can support the first rotating shaft 31, so that the first rotating shaft 31 in sliding contact with the rotating member 20 can support the rotating member 20.

In some embodiments, a bearing is further inserted into the assembly hole 221, and the bearing is sleeved on the first rotating shaft 31 to support the rotation of the first rotating shaft 31, making the rotation of the first rotating shaft 31 smoother.

In some embodiments, the first rotating shaft 31 is a metal or plastic part.

During use, the first rotating shaft 31 needs to be in rotational contact with the rotating member 20 for a long term and needs to provide some support for the rotating member 20 when hovering, so configuring the first rotating shaft 31 as a metal part or a plastic part with high hardness can increase the structural strength of the first rotating shaft 31, thereby prolonging the service life of the first rotating shaft 31.

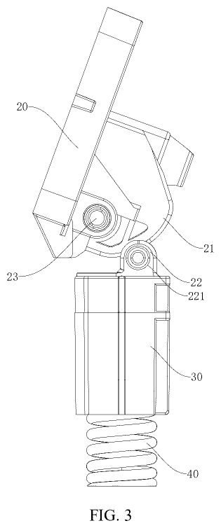

As shown in FIG. 2, in some embodiments, a stop portion 32 is provided on the protrusion 22, the stop portion 32 is arranged on an outer side of the first rotating shaft 31, and the stop portion 32 is spaced apart from the cam portion 21. Understandably, during use, the first rotating shaft 31 needs to be in rotational contact with the rotating member 20 for a long term and needs to provide some support for the rotating member 20 when hovering, so the stop portion 32 can provide support for the first rotating shaft 31, which can further improve the stability of the rotating member 20 staying in that position and maintain balance and stability.

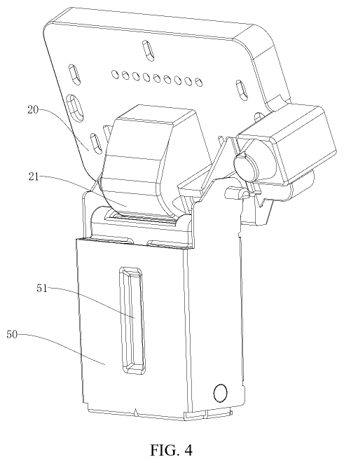

As shown in FIG. 4, the rotating shaft module according to the embodiments of the present application further includes a second support member 50, the second support member 50 is arranged in the first mounting cavity, the second support member 50 is detachably connected to the first support member 10, the second support member 50 further defines a second mounting cavity, the rotating member 20 is rotatably connected to both the first support member 10 and the second support member 50, and the slider 30 and the elastic member 40 are both arranged in the second mounting cavity.

In detail, the second support member 50 and the first support member 10 jointly support the rotating member 20, which can better distribute the force on the single support members (the first support member 10 and the second support member 50) and avoid embrittlement and cracking of the first support member 10 during long-term use, thereby prolonging the service life of the rotating shaft module.

The second support member 50 defines the second mounting cavity, and the second mounting cavity may be configured in any desired shape, such as rectangular, cubic, cylindrical, or elliptical cylindrical. In the embodiment shown in FIG. 1, the second mounting cavity is configured in a rectangular shape.

As shown in FIG. 4, in some embodiments, the first support member 10 is provided with a guide portion, the second support member 50 is provided with a guide groove 51, and the guide portion is clamped into the guide groove 51.

In this way, the positioning fit between the first support member 10 and the second support member 50 can be achieved, to prevent the first support member 10 and the second support member 50 from being misaligned and shaking during use. Meanwhile, the guide portion and the guide groove 51 can play a guiding role in the assembly and disassembly process of the first support member 10 and the second support member 50, thereby simplifying the assembly and disassembly process of the first support member 10 and the second support member 50 and achieving a fool-proofing effect.

In some embodiments, the limit groove is defined on the slider 30, and the elastic member 40 is clamped in the limit groove, thereby preventing the elastic member 40 from getting stuck during compression and expansion and always maintaining effective abutment between the slider 30 and the elastic member 40.

In the rotating shaft module according to the embodiments of the utility model, the strength of the first support member 10 is less than that of the second support member 50. Because the second support member 50 is arranged inside the first support member 10, the second support member 50 is closer to the rotating member 20, especially when bearing the horizontal lateral component force applied by the rotating member 20, the second support member 50 bears larger force. Therefore, the strength of the first support member 10 is less than that of the second support member 50, that is, the strength of the second support member 50 is greater than that of the first support member 10, which can satisfy the structural strength and reduce the structural strength standard of the first support member 10, thereby achieving the effects of cost reduction and efficiency improvement.

In the rotating shaft module according to the embodiments of the utility model, the first support member 10 defines first opposite shaft holes, the second support member 50 defines second opposite shaft holes, the second shaft holes are opposite to the first shaft holes, the rotating member 20 is provided with two rotating shaft portions, and the rotating shaft portions are sequentially inserted into the second shaft holes and the first shaft holes in a direction where the two rotating shaft portions are away from each other.

Specifically, each rotating shaft portion is simultaneously inserted into the first shaft hole and the second shaft hole. The two symmetrically distributed rotating shaft portions can ensure that the rotation of the rotating member 20 is smoother and the force can be more balanced, thereby preventing the rotating member 20 from tilting and jamming due to uneven force during rotation.

As shown in FIG. 1 and FIG. 3, in some embodiments, the rotating member 20 is provided with an assembly hole 221 and a second rotating shaft 23, the second rotating shaft 23 includes a connecting portion and rotating shaft portions located at two ends of the connecting portion, and the connecting portion is inserted into the assembly hole 221. During assembly, the assembly hole 221 can be first aligned with the first shaft holes and/or the second shaft holes (the first shaft holes and the second shaft holes are aligned after assembly), and then the second rotating shaft 23 is sequentially inserted into the first shaft hole, the second shaft hole, the assembly hole 221, the second shaft hole, and the first shaft hole. When disassembly and maintenance are required later, the second rotating shaft 23 is sequentially pulled out from the first shaft hole, the second shaft hole, the assembly hole 221, the second shaft hole, and the first shaft hole. This can simplify the assembly of the rotating member 20, the first support member 10, and the second support member 50.

In some embodiments, the connecting portion and the two rotating shaft portions are integrally formed.

In some embodiments, the second support member 50 is a metal part, which can increase the structural strength of the second support member 50.

In a first embodiment:

The second support member 50 is configured as a first metal part, and the second rotating shaft 23 is configured as an integrally formed second metal part.

Specifically, the second support member 50 is configured as the first metal part, that is, the second support member 50 is made of a metal material. The second rotating shaft 23 is configured as the second metal part, that is, the second rotating shaft 23 is also made of a metal material. The first metal part and the second metal part mean that the metal materials for making the second support member 50 and the second rotating shaft 23 may be the same or different, are not correlated with each other, and can be set according to needs. In addition, the integral formation of the second rotating shaft 23 can further simplify the production process, increase the structural strength of the second rotating shaft 23, and prolong the service life of the second rotating shaft 23.

In the rotating shaft module according to the embodiment of the utility model, the second support member 50 is configured as the first metal part, and the second rotating shaft 23 is configured as the integrally formed second metal part, which can better increase the structural strength of the second support member 50 and the second rotating shaft 23, thereby ensuring that the second support member 50 is less prone to deformation during long-term use and ensuring support force.

In a second embodiment:

The first support member 10 is configured as a plastic part, which can ensure the structural strength, effectively reduce the production cost and prevent waste caused by excessive settings.

A functional device according to the embodiments of the present application includes the aforementioned rotating shaft module.

In the functional device according to the embodiments of the present application, the first rotating shaft 31 is in contact with the rotating member 20, and the first rotating shaft 31 can rotate during the contact with the rotating member 20, thereby reducing friction of the rotating member 20 on the slider 30 and prolonging the service life of the slider 30.

The functional device may be a multi-functional peripheral or a copy machine.

It should be understood that the terms used herein are only for the purpose of describing specific exemplary implementations and are not intended to be restrictive. Unless otherwise explicitly stated in the context, singular forms such as “a”, “one”, and “the” used herein may further include plural forms. The terms “comprise”, “include”, “contain”, and “have” are inclusive and therefore indicate the existence of the stated features, steps, operations, elements, and/or components, but do not exclude the existence or addition of one or more other features, steps, operations, elements, components, and/or combinations thereof. The method steps, processes, and operations described herein are not interpreted as requiring them to be executed in a specific order described or illustrated, unless an execution order is clearly indicated. It should also be understood that additional or alternative steps can be used.

Although the terms first, second, third, etc. can be used herein to describe a plurality of elements, components, regions, layers, and/or segments, these elements, components, regions, layers, and/or segments should not be limited by these terms. These terms can only be used for distinguishing one element, component, region, layer, or segment from another. Unless explicitly stated in the context, the terms such as “first” and “second” and other numerical terms used herein do not imply order or sequence. Therefore, the first element, component, region, layer, or segment discussed below may be referred to as the second element, component, region, layer, or segment without departing from the teachings of the example embodiments.

Described above are merely specific implementations of the utility model, which enable those skilled in the art to understand or implement the utility model. Various modifications to these embodiments will be apparent to those skilled in the art, and the general principles defined herein can be implemented in other embodiments without departing from the spirit or scope of the utility model. Therefore, the utility model will not be limited to the embodiments shown herein, but conforms to the widest scope consistent with the principles and novelty characteristics applied herein.

What is claimed is:

1. A rotating shaft module, comprising:
a first support member defining a first mounting cavity;
a rotating member rotatably connected to the first support member;
a slider movably arranged in the first mounting cavity, wherein a first rotating shaft is mounted at the end of the slider close to the rotating member, and the rotating member can abut against the first rotating shaft; and
an elastic member arranged in the first mounting cavity, located on the side of the slider away from the rotating member and abutting against the slider.

2. The rotating shaft module according to claim 1, wherein the rotating member comprises a cam portion, the slider comprises a protrusion, the first rotating shaft is provided on the protrusion, and the cam portion abuts against the first rotating shaft.

3. The rotating shaft module according to claim 2, wherein the protrusion is provided with a limit groove, and a portion of the first rotating shaft is embedded into the limit groove.

4. The rotating shaft module according to claim 2, wherein the protrusion is provided with two opposite assembly holes, and the first rotating shaft is inserted into the assembly holes.

5. The rotating shaft module according to claim 4, wherein a bearing is further inserted into the assembly hole, and the bearing is sleeved on the first rotating shaft.

6. The rotating shaft module according to claim 2, wherein the first rotating shaft is a metal or plastic part.

7. The rotating shaft module according to claim 6, wherein a stop portion is provided on the protrusion, the stop portion is arranged on an outer side of the first rotating shaft, and the stop portion is spaced apart from the cam portion.

8. The rotating shaft module according to claim 5, wherein a stop portion is provided on the protrusion, the stop portion is arranged on an outer side of the first rotating shaft, and the stop portion is spaced apart from the cam portion.

9. The rotating shaft module according to claim 1, further comprising a second support member, wherein the second support member is arranged in the first mounting cavity, the second support member is detachably connected to the first support member, the second support member further defines a second mounting cavity, the rotating member is rotatably connected to both the first support member and the second support member, and the slider and the elastic member are both arranged in the second mounting cavity.

10. The rotating shaft module according to claim 9, wherein the second support member is a metal part; and/or the first support member is provided with a guide portion, the second support member is provided with a guide groove, and the guide portion is clamped into the guide groove.

11. A functional device, comprising the rotating shaft module according to claim 1.
